(19) United States
(12) Patent Application Publication
(10) Pub. No.: US 2024/0424464 A1
(43) Pub. Date: Dec. 26, 2024

(54) HIGHLY STABLE METAL HALIDE PEROVSKITE COLLOIDAL COMPOSITIONS

(71) Applicant: University of Kansas, Lawrence, KS (US)

(72) Inventors: Maogang Gong, Lawrence, KS (US); Judy Z. Wu, Lawrence, KS (US)

(21) Appl. No.: 18/274,058

(22) PCT Filed: Jan. 24, 2022
(86) PCT No.: PCT/US22/13454

§ 371 Date: Jul. 25, 2023

Related U.S. Application Data
(60) Provisional application No. 63/141,588, filed on Jan. 26, 2021.

(51) Int. Cl. B01J 13/00; B82Y 15/00; B82Y 40/00

(52) U.S. Cl. CPC B01J 13/0034; B01J 13/0026; B82Y 15/00; B82Y 40/00

(57) ABSTRACT

Stabilized colloidal compositions and methods of making and using the compositions are provided. In embodiments, a stabilized colloidal composition comprises metal halide perovskite nanocrystals dispersed within a liquid phase medium comprising a synthesis solution from which the metal halide perovskite nanocrystals were synthesized, the synthesis solution comprising a dynamic binding compound capable of forming a covalent bond to surfaces of the metal halide perovskite nanocrystals as a dynamic binding ligand; and a stability promoter.

### CROSS-REFERENCE TO RELATED APPLICATIONS

The present application claims priority to U.S. Provisional Patent Application No. 63/141,588 that was filed Jan. 26, 2021, the entire disclosure of which is hereby incorporated by reference.

### REFERENCE TO GOVERNMENT RIGHTS

This invention was made with government support under DE-NA0002839 awarded by the Department of Energy, W911NF-16-1-0029 awarded by the Army Research Office, and 1508494, 1909292, 1809293, and 1809284 awarded by the National Science Foundation. The government has certain rights in the invention.

### BACKGROUND

After the report of the first metal halide perovskites (MHPs) as visible light sensitizers for photovoltaics, the last decade has brought surging interests in MHPs, including both organic-inorganic (hybrid) and all inorganic, driven by their unique physical properties that can enable a spectrum of applications including solar cells, light-emitting devices, television displays, photodetectors, X-ray imagers, scintillators, lasers, etc. Among the various forms of MHPs, MHP nanocrystals (NCs) have unique advantages including high quantum efficiency, narrow band photoluminescence (PL), and tunable light absorption from ultraviolet to near-infrared wavelengths by varying halide compositions. Despite exciting progress made in MHPs, the ambient instability of MHPs remains the foremost challenge to their practical applications. This issue is more serious for MHP NCs, including all-inorganic MHP NCs, due to their larger surface-to-volume ratio as compared to bulk materials and thin films. The instability issue of MHPs stems from the intrinsic chemical instability of the MHPs due to the low energies of the MPH structure formation, which translates into low energy barriers for MHP phase decomposition in ambient. This decomposition can be accelerated by moisture, oxygen, chemicals, heat, and light illumination.

### SUMMARY

Provided are stabilized colloidal compositions comprising metal halide perovskite nanocrystals. Methods of making and using the compositions are also provided. The present disclosure is based on the inventors' greater understanding of the mechanism underlying the instability of metal halide perovskite nanocrystals—the dynamic exchange of ligands between the surface of the nanocrystals and the surrounding solution. These ligands are derived from compounds present during the synthesis of the nanocrystals. Their intermittent, but persistent, attaching/detaching from the surface of the nanocrystals exposes the surface to attack by harmful species in the surrounding environment, leading to degradation of the nanocrystals. Prior efforts at improving stability have focused on using different types of ligands to more strongly bind to the surface of the nanocrystals. The inventors have found that such efforts are insufficient. Instead, it is found that certain compounds (herein referred to as stability promoters) may be added in certain amounts to synthesis solutions comprising the metal halide perovskite nanocrystals. This approach achieves suppression of dynamic ligand exchange and promotes the strong covalent binding of ligands derived from compounds present during synthesis, e.g., oleylamine and oleic acid. The result is a remarkable improvement in stability. For example, using this approach, the stability of CsPbI₃ nanocrystals in solution at ambient was improved by two orders of magnitude, from about 2 hours to about 200 hours. The approach also allows solutions of CsPbBrI₂ nanocrystals to remain stable under ambient conditions for at least 10 months.

Stabilized colloidal compositions are provided. In embodiments, a stabilized colloidal composition comprises metal halide perovskite nanocrystals dispersed within a liquid phase medium comprising a synthesis solution from which the metal halide perovskite nanocrystals were synthesized, the synthesis solution comprising a dynamic binding compound capable of forming a covalent bond to surfaces of the metal halide perovskite nanocrystals as a dynamic binding ligand; and a stability promoter.

Methods of making and using the stabilized colloidal compositions are also provided.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1A is a schematic illustration of an INPC and three types of ligands bound to its surface, including an L-type ligand (Lewis bases that provide two electrons to the IPNC-ligand bond), a Z-type ligand (Lewis acids that provide empty orbital), and an X-type ligand (each X offering one electron). FIG. 1B is a schematic illustration of the types of ligands provided by oleylamine (OLA) and oleic acid (OA). The amine group of OLA is shown on top, which can bind relatively weakly as an L-type ligand. The formation of oleylammonium halide from OLA and a hydrogen halide is shown on the left, allowing for stronger binding as an X-type ligand. The formation of oleylammonium oleate from OLA and OA is shown on the right, allowing for stronger binding as an X-type ligand. These species and an illustration of the dynamic surface ligand exchange process is further illustrated in FIG. 1C. As shown in FIG. 1C, 1-octadecene may also bind as an L-type ligand. FIG. 1D shows a schematic illustration of an IPNC in its synthesis solution (SS) prior to the addition of hexane (left) and after the addition of hexane (right). The addition of hexane (at certain amounts) results in more complete encapsulation by strongly covalently bound oleylammonium halide and oleylammonium oleate.

FIG. 2A shows photoluminescence (PL) spectra from pristine (as-synthesized) CsPbCl₃, CsPbBr₃, CsPbI₃, and CsPbBrI₂ IPNCs in SS only (no hexane) (solid line) and after storage in SS only (no hexane) at ambient for 1 day (dotted line). The PL was quenched for CsPbI₃ after 1 day. FIG. 2B shows PL peak intensity as function of time for CsPbCl₃, CsPbBr₃, CsPbI₃, and CsPbBrI₂ in SS:hexane at a volume ratio of 1:12.

FIG. 3A shows a stacked plot of 1D ¹H spectra of CsPbBrI₂ IPNCs, hexane, 1-Octadecene, Oleic acid, Oleylamine, and Trioctylphosphine in CDCl₃ at 500 MHz. FIG. 3B shows the 2D ¹H-¹H NOESY spectrum of CsPbBrI₂ IPNCs in CDCl₃ (specifically, an aliquot from the SS:hexane solution containing the CsPbBrI₂ IPNCs) at 500 MHz.

FIGS. 4A-4C show the results of experiments examining the stability of the CsPbBrI₂ IPNCs in SS:hexane across a range of volume ratios from 1:1 to 1:12. FIG. 4A shows the PL intensity of CsPbBrI₂ IPNCs (and CsPbI₃ IPNCs in the inset) as function of the SS:hexane volume ratio. FIG. 4B shows the PL intensity of CsPbBrI₂ IPNCs as function of time. FIG. 4C shows PL spectra from pristine (as-synthesized) CsPbBrI₂ IPNCs, after 2 days storage in SS only (no hexane) at ambient and after 300 days storage in mixed SS:hexane at a volume ratio of 1:12 (ambient).

FIG. 5A shows a schematic of the ligand-anchored (LA)-CsPbBrI₂ IPNCs/graphene photodetector. FIG. 5B shows an energy level diagram of the heterojunction in the photodetector of FIG. 5A and charge transfer process under illumination and exciton generation. FIG. 5C plots the dynamic photoresponse of a CsPbBrI₂ IPNCs (no hexane treatment)/graphene photodetector and a LA-CsPbBrI₂ IPNCs (hexane treatment)/graphene photodetector under 600 nm illumination with power density of 26.8 μW/cm². The graphene channel length and width were 4.5 μm and 11.2 μm, respectively. FIG. 5D plots the photocurrent evolution of photodetectors based on CsPbBrI₂ IPNCs (no hexane treatment)/graphene and LA-CsPbBrI₂ IPNCs (hexane treatment)/graphene. Photocurrent was monitored under ambient condition at 50±5% humidity.

### DETAILED DESCRIPTION

Provided are stabilized colloidal compositions comprising metal halide perovskite nanocrystals. Methods of making and using the compositions are also provided.

In one aspect, stabilized colloidal compositions are provided. The stabilized colloidal compositions comprise metal halide perovskite nanocrystals dispersed within a liquid phase medium comprising a synthesis solution and a stability promoter. The synthesis solution comprises the chemical species which were used to synthesize the metal halide perovskite nanocrystals, including dynamic binding compounds. The term “colloidal” and the like refer to the homogeneous and uniform dispersion of the metal halide perovskite nanocrystals throughout a continuous phase provided by the liquid phase medium.

The metal halide perovskite of the nanocrystals may be a compound having Formula I, ABX₃, wherein A and B are cations having different sizes (i.e., ionic radii). One or both of A and B are selected from metals and X is selected from halogens. In embodiments, both A and B are selected from metals. Such metal halide perovskites may be referred to as “all inorganic” metal halide perovskites. In embodiments, the metal halide perovskite has Formula IA, APbX₃, wherein A is selected from alkali metals and X is selected from halogens. In embodiments, the metal halide perovskite has Formula IB, CsPbX₃, wherein X is selected from halogens. Combinations of different types of metal halide perovskites may be used.

The formulas above encompass doped or alloyed or mixed metal halide perovskites, i.e., compounds which include more than one type of A cation (e.g., two, three, etc.) in varying relative amounts (provided the sum of the amounts is about 1 atom per a structural A-site), more than one type of B cation (e.g., two, three, etc.) in varying relative amounts (provided the sum of the amounts is about 1 atom per a structural B-site), more than one type of X anion (e.g., two, three, etc.) in varying relative amounts (provided the sum of the amounts is about 3), or combinations thereof. By way of illustration, metal halide perovskites having formula AB(X₁)_{z}(X₂)_{3-z}, wherein z ranges from about 0 to about 3 are encompassed by Formula I.

The formulas above also encompass compounds in which the amounts of the elements (i.e., A, B, X) may deviate from ideal, e.g., non-stoichiometric compounds. For example, the deviation may be up to about 10% in cations (A or B) and up to about 20% in halogens. By way of illustration, this means that the formulas encompass compounds such as ABX_{2.98}, ABX_{2.5}, A_{0.95}BX₃, etc.

The term “nanocrystals” refers to the metal halide perovskites being in the form of particles having a largest cross-sectional dimension of no greater than 1000 nm. This includes particles having a largest cross-sectional dimension of no greater than 500 nm, no greater than 250 nm, no greater than 100 nm, no greater than 50 nm, no greater than 10 nm, or in the range of 1 nm to 500 nm. These dimensions may refer to the average largest cross-sectional dimension for the collection of nanocrystals.

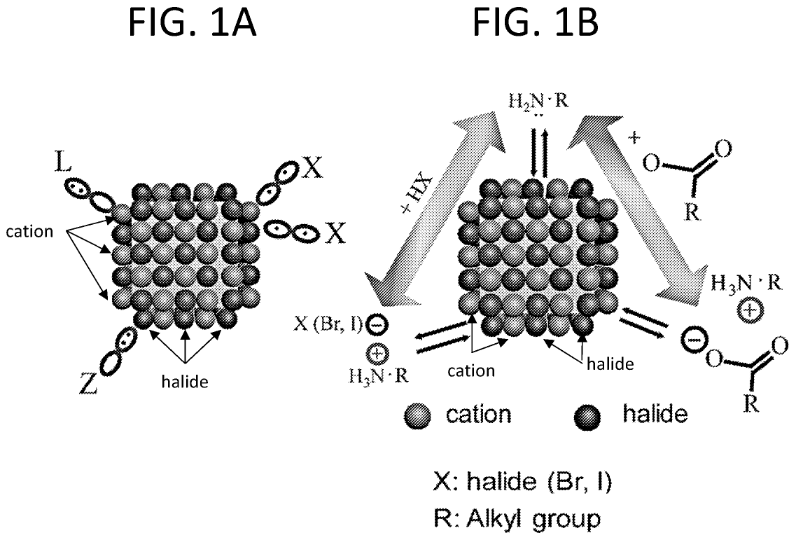

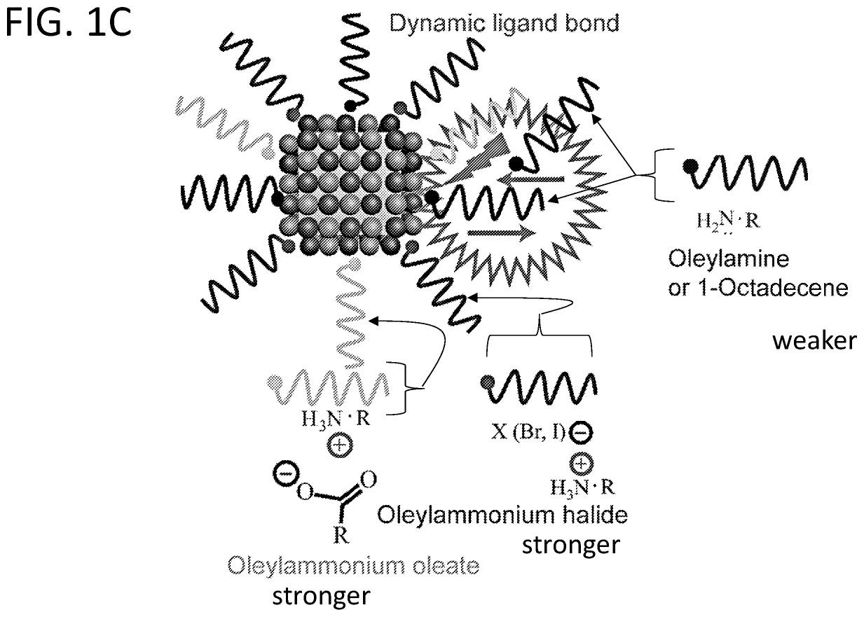

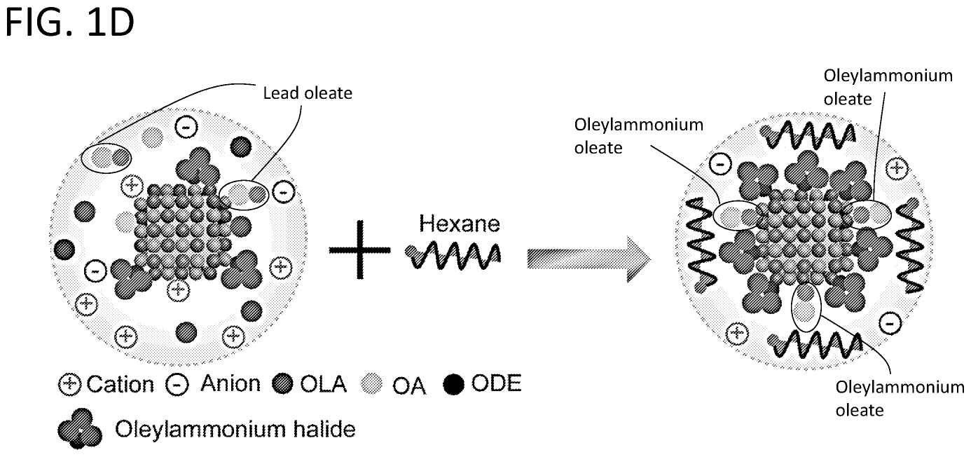

As noted above, the synthesis solution comprises dynamic binding compounds. Dynamic binding compounds are compounds capable of covalently binding to the surfaces of the metal halide perovskite nanocrystals (i.e., via certain functional groups). These functional groups may be those inherently present in the dynamic binding compounds or those which are generated due to the presence of other components in the synthesis solution. By way of illustration, oleylamine is an illustrative dynamic binding compound. As shown in FIG. 1A-1C, oleylamine itself can covalently bind to a metal halide perovskite nanocrystal as an L-type ligand. In addition, in the presence of hydrogen halides in the synthesis solution, oleylamine forms an oleylammonium halide which can covalently bind to a metal halide perovskite nanocrystal as an X-type ligand. Oleic acid is another illustrative dynamic binding compound. Oleic acid can be deprotonated by oleylamine, and the two dynamic binding compounds then form oleylammonium oleate, which can covalently bind to a metal halide perovskite nanocrystal as an X-type ligand.

It is noted that the chemical compound covalently bound to the surface to the metal halide perovskite is generally referred to as a “dynamic binding ligand” (or simply, “ligand”) but in some instances of the present disclosure, this phrase may be used interchangeably with the phrase “dynamic binding compound.” The liquid phase medium of the present compositions may be considered to comprise both the dynamic binding compounds (e.g., oleylamine, oleic acid) and the dynamic binding ligands derived therefrom (e.g., oleylammonium halide, oleylammonium oleate), which may be covalently bound to the surfaces of the metal halide perovskite nanocrystals. As illustrated in FIG. 1C, the phrase “dynamic binding” is used because this covalent binding is dynamic such that the dynamic binding ligands continuously become bound/unbound and exchange with one another within the liquid phase medium.

Although not shown in FIG. 1B, other types of dynamic binding ligands bound via other types of covalent bonds may be used, e.g., Z-type ligands as shown in FIG. 1A. The different types of dynamic binding ligands and covalent bonds formed by each may have different strengths. By way of illustration, the L-type ligand oleylamine, forms a relatively weaker covalent bond as compared to the covalent bonds formed by the X-type ligands, oleylammonium halide and oleylammonium oleate.

In addition to oleylamine and oleic acid, other similar dynamic binding compounds may be used in the synthesis solution, including other types of fatty acids, fatty amines, and combinations thereof. Illustrative dynamic binding compounds include decanoic acid, undecylenic acid, myristic acid, stearic acid, octadecylamine, dodecylamine, etc., and combinations thereof. In embodiments, at least two different types of dynamic binding compounds are used, resulting in two different types of covalent bonds having different strengths, e.g., oleylamine and oleic acid, resulting in relatively weak L-type ligands and relatively strong X-type ligands as described above.

The synthesis solution may comprise other components, including compounds for solubilizing the selected dynamic binding compounds (e.g., an organic solvent) and/or any other compound/species involved in the synthesis of the metal halide perovskite nanocrystals. Illustrative such compounds/species include octadecene and trioctylphosphine. Both octadecene and trioctylphosphine may referred to as dynamic binding compounds as they are also able to bind to the surface of the metal halide perovskite nanocrystals. The amount of the metal halide perovskite nanocrystals in the liquid phase medium as well as the relative amounts of the dynamic binding compounds and other components of the synthesis solution are generally selected to achieve a colloidal dispersion, i.e., a homogeneous and uniform dispersion of the metal halide perovskite nanocrystals throughout the liquid phase medium as described above. However, as synthesized, such a colloidal dispersion is relatively unstable in the absence of the stability promoter. Such instability is further described below and in the subsequent Example.

The present stabilized colloidal compositions further comprise a stability promoter dispersed within the liquid phase medium. Without wishing to be bound to a particular theory, it is thought that the stability promoters improve the stability of the colloidal dispersions described above by suppressing the dynamic exchange of the dynamic binding ligands and/or promoting the binding of those ligands having relatively stronger covalent bonds to the metal halide perovskite nanocrystals (e.g., X-type ligands) over those ligands having relatively weaker covalent bonds (e.g., L-type ligands). This is illustrated in FIGS. 1C and 1D. Whether the stability promoter is capable of suppressing dynamic ligand exchange while promoting the binding of strong covalently bound ligands depends upon the type of stability promoter and the amount used.

Suitable stability promoters are generally nonpolar, organic compounds. Illustrative such compounds include alkanes, including unsubstituted, linear alkanes. In embodiments, the number of carbon atoms in the alkane in is a range of from 5 to 59. In embodiments, the number of carbon atoms in the alkane in is a range of from 5 to 16. This includes alkanes having 6, 7, 8, 9, 10, 11, 12, 13, 14, 15, or 16 carbons. Illustrative alkanes include pentane, hexane, heptane, octane, nonane, decane, undecane, dodecane etc. Combinations of different types of stability promoters may be used.

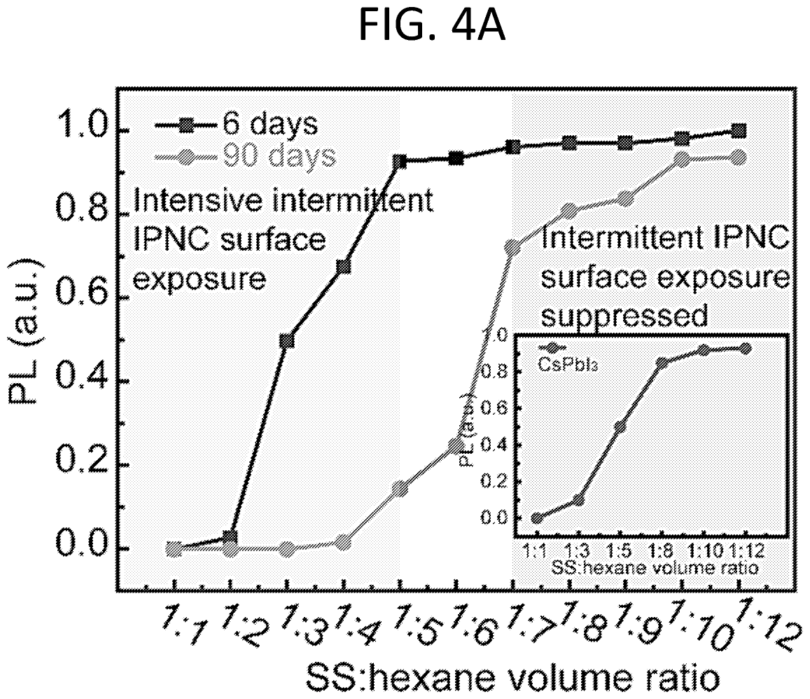

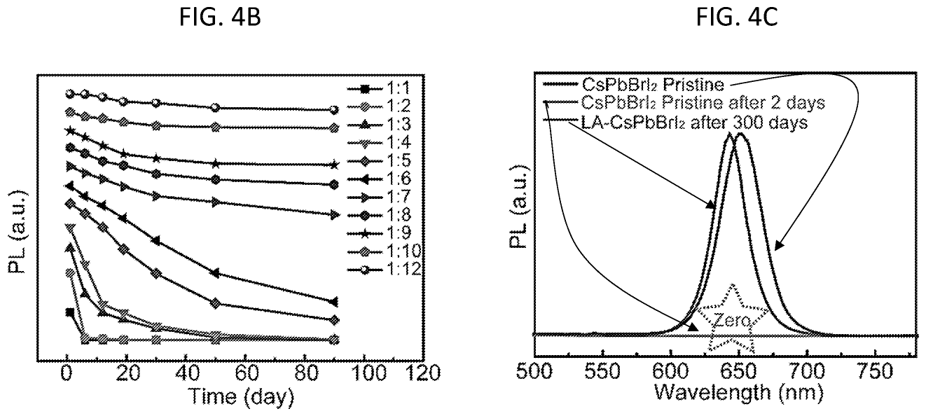

The amount of the stability promoter used depends upon the selected colloidal dispersion, including the selected type of metal halide perovskite nanocrystals. However, it has been found that there generally exists a threshold amount of the stability promoter below which amount no improvement, or a limited improvement, in stability is observed. (See FIG. 4C.) In embodiments, the volume ratio of (synthesis solution):(stability promoter) is at least 1:5. This includes at least 1:6, at least 1:7, at least 1:8, at least 1:9, at least 1:10, and in a range of from 1:5 to 1:20, from 1:6 to 1:18, from 1:7 to 1:15, and from 1:8 to 1:14. Thus, the present stabilized colloidal compositions may comprise no more than 95% of the stability promoter, including no more than 90%, no more than 85%, and no more than 80%. (These are all volume percentages.) The present stabilized colloidal compositions may comprise at least 5% of the synthesis solution, including at least 10%, at least 15%, and at least 20%. (Again, these are all volume percentages.)

The stability of the present stabilized colloidal compositions may be quantified from photoluminescence spectra obtained from the stabilized colloidal compositions as described in the Example, below. (See FIG. 4C.) Such a spectrum will exhibit a peak due to the metal halide perovskite nanocrystals therein. Stability may be quantified by measuring the intensity of the peak over time, with reductions in intensity as compared to an initial time point corresponding to decreased stability. The initial time point refers to the first measurement made after synthesis of the stabilized colloidal composition, generally within the same day as the synthesis, i.e., day 0. The present compositions may be characterized by a reduction in intensity of no more than 25%, no more than 20%, no more than 15%, no more than 10%, or no more than 5% after 90 days as compared to the initial time point, e.g., day 0. These values are in stark contrast to those obtained from comparative colloidal compositions having the same composition as the stabilized colloidal compositions except which do not include the stability promoter. Such comparative colloidal compositions are often characterized by a complete reduction in intensity (i.e., 100%) after 90 days.

The present stabilized colloidal compositions are distinguished from compositions comprising metal halide nanocrystals which may have been purified but have not been exposed to a stability promoter in the synthesis solution as described herein. As described above, the present stabilized colloidal compositions comprise the synthesis solution—the solution in which the metal halide perovskite nanocrystals were synthesized. By contrast, the purification process necessarily involves removal of the nanocrystals from the synthesis solution, generally by precipitating the nanocrystals out of the synthesis solution using a polar solvent. Thus, most of the chemical species from the synthesis solution will also be removed during purification and will not be present in a composition comprising purified metal halide nanocrystals. Generally, purification will remove more than 98 volume percent (including more than 99 volume percent and more than 99.9 volume percent) of any chemical species present in the synthesis solution such that less than 2 volume percent (including less than 1 volume percent and less than 0.1 volume percent) of such chemical species may be left in a composition comprising purified metal halide nanocrystals.

By contrast, the liquid phase medium of the present stabilized colloidal compositions comprises a greater amount of the dynamic binding compounds (e.g., oleylamine and oleic acid) and associated synthesis compounds or other dynamic binding compounds (e.g., octadecene and trioctylphosphine) as compared to compositions comprising purified metal halide nanocrystals. Similarly, the present stabilized colloidal compositions also generally comprise a smaller amount of the stability promoter as compared to compositions comprising purified metal halide nanocrystals. The liquid phase medium of the present stabilized colloidal compositions may comprise at least 5% of the dynamic binding compounds/associated synthesis compounds, including at least 10%, at least 15%, and at least 20%. (These are all volume percentages). The liquid phase medium of the present stabilized colloidal compositions may comprise no more than 95% of the stability promoter, including no more than 90%, no more than 85%, and no more than 80%. (Again, these are all volume percentages).

The metal halide perovskite nanocrystals of the present stabilized colloidal compositions are also more passivated, i.e., have a greater surface coverage of covalently bound ligands, as compared to compositions comprising metal halide nanocrystals which may have been purified but have not been exposed to a stability promoter in the synthesis solution as described herein. The type of covalently bound ligands depends upon the dynamic binding compounds used, but NMR techniques (described in the Example below) may be used to determine the chemical identity of the covalently bound ligands. NMR techniques such as Diffusion Ordered NMR Spectroscopy (DOSY) may be used to quantify surface coverage. In embodiments, the covalently bound ligands comprise oleylammonium halide and oleylammonium oleate. In embodiments, the total surface coverage of these covalently bound ligands is at least 2 ligands/nm² or at least 3 ligands/nm². Without treatment using a stability promoter as described herein, surface coverages would be substantially less.

Finally, related to the greater passivation of the metal halide perovskite nanocrystals, the present stabilized colloidal compositions are also more stable as compared to compositions comprising metal halide nanocrystals which may have been purified but have not been exposed to a stability promoter in the synthesis solution as described herein. Stability may be quantified as described above and the present stabilized colloidal compositions may be characterized by any of the stability properties as described above.

In embodiments, the liquid phase medium of the present stabilized colloidal compositions may consist of the synthesis solution and the stability promoter. The synthesis solution may consist of one or more dynamic binding compounds and optionally, an organic solvent. In embodiments, the synthesis solution consists of dynamic binding compounds selected from the group consisting of 1-octadecene, oleylamine, oleic acid, trioctylphosphine, and combinations thereof. However, the phrase “consisting of” allows for the presence of typical manufacturing impurities associated with these components, including the impurities listed in the Example, below. In such embodiments, 1-octadecene may be used in an amount of from 60 to 80 volume percent; oleylamine may be used in an amount of from 2 to 12 volume percent; oleic acid may be used in an amount of from 2 to 12 volume percent; and trioctylphosphine may be used in an amount of from 8 to 20 volume percent.

Methods of making the stabilized colloidal compositions are also provided. In embodiments, such a method comprises adding a stability promoter to an amount of a dispersion of metal halide perovskite nanocrystals in a synthesis solution comprising dynamic binding compounds. Any of the stability promoters, metal halide perovskite nanocrystals, and dynamic binding compounds described herein may be used. The volume ratio of the stability promoter and the dispersion may be within the ranges described herein. The methods may further comprise forming the dispersion, e.g., according to the synthetic techniques described in the Example, below.

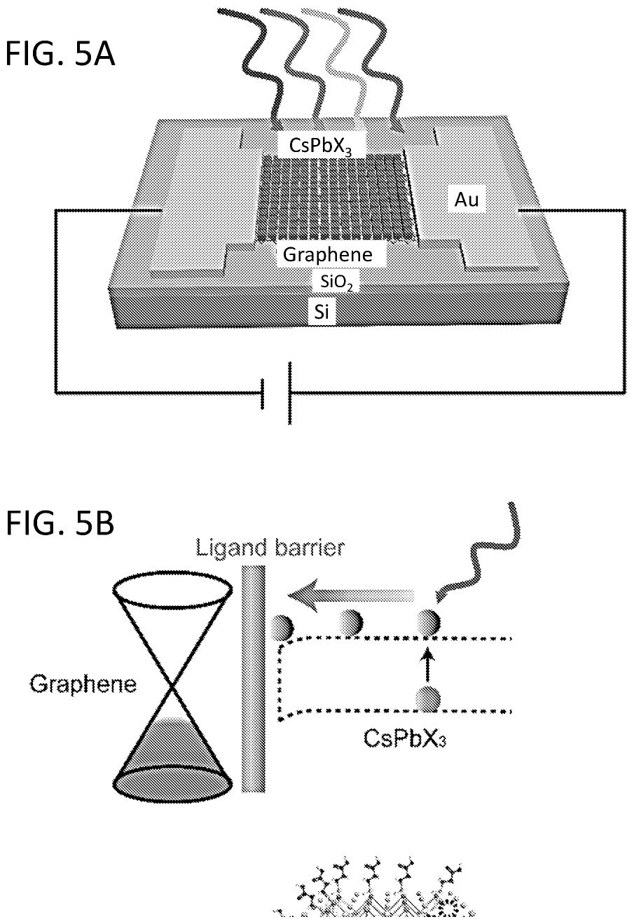

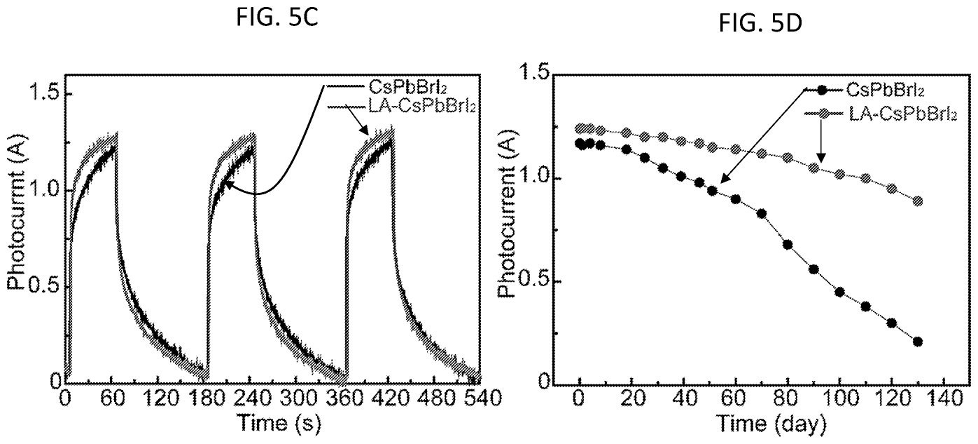

Methods of using the stabilized colloidal compositions are also provided. Generally, the present compositions may be used in any application in which the metal halide perovskite nanocrystals are desired, including in the fabrication of devices based on such nanocrystals, e.g., photodetectors. Notably, the improved stability of the stabilized colloidal compositions described above is maintained through additional processing steps such as purification and device fabrication. This is also demonstrated in the Example, below. Thus, various methods of using the present compositions may include one or more of the following steps: precipitating the metal halide perovskite nanocrystals from the stabilized colloidal composition using a polar solvent; redispersing the precipitated metal halide perovskite nanocrystals in a non-polar solvent; printing the redispersed metal halide perovskite nanocrystals on a substrate (e.g., graphene); and exposing the printed metal halide perovskite nanocrystals to a hybrid ligand composition comprising a conductive ligand (e.g., 3-mercaptopropionic acid) and a halide compound (e.g., lead chloride). These steps may be used to form a photodetector which exhibits high photocurrent and fast photoresponse even after extended periods of time (e.g., more than 4 months). (See FIG. 5D.) The resulting photodetectors are also encompassed by the present disclosure.

### EXAMPLE

### Introduction

The instability of colloidal iodine-based inorganic perovskite CsPbX₃ (X=Cl, Br, I) nanocrystals (IPNCs) represents a major obstacle in lead-halide IPNC research and applications. Herein, a ligand-anchoring process is described that enables significantly improved colloidal stability of the iodine-based IPNCs for over 10 months in ambient. Previous efforts to address IPNC instability focused on using different types of ligands to cap the IPNCs. By contrast, the ligand-anchoring method described in this Example demonstrates that remarkable improvements in stability are achieved by suppressing the dynamic ligand exchange process in colloidal IPNC solutions. Specifically, it is shown that adding certain volume portions of a stability promoter such as hexane to IPNC synthesis solutions containing oleic acid (OA) and oleylamine (OLA) suppresses dynamic ligand exchange and promotes the anchoring of strongly bound ligands derived from these compounds (i.e., oleylammonium halide and oleylammonium carboxylate) to the IPNC surfaces. This treatment leads to ligand-anchored iodine-based IPNCs (LA-IPNCs) having superior stability as confirmed using optical absorption, photoluminescence, ¹H solution nuclear magnetic resonance spectroscopy, and photoresponse measurements. For example, the stability of CsPbI₃ IPNCs was improved by two orders of magnitude, from 1 to 2 hours in the original synthesis solution (no hexane added) to 200 hours in a hexane-added synthesis solution (volume ratio of synthesis solution (SS):hexane of 1:12). Together, the results have revealed that the intermittent, but persistent, exposure of the IPNC surface during dynamic ligand exchange is the primary mechanism underlying the colloidal IPNC instability, which can be dramatically improved by the addition of hexane to the synthesis solution.

### Experimental

Synthesis of CsPbX₃ IPNCs: Lead (II) Chloride (PbCl₂, 99.999% trace metals basis), Lead (II) Bromide (PbBr₂, 99.999% trace metals basis), Lead (II) Iodide (PbI₂, 99.999% trace metals basis), Cesium Carbonate (Cs₂CO₃, 99%), Dichloromethane (CH₂Cl₂, ≥99.8%), Oleylamine (OLA, 70%, with about 30% of trans isomer and shorter chain and unsaturated amines), 1-Octadecene (ODE, 90%, with about 10% made up of 2-octyl-1-decene, n-octadecane, 2-butyl-1-tetradecene, 2-hexyl-1-dodecene), Trioctylphosphine (TOP, 90%, with about 10% made up of phosphorus-containing compounds, such as Tri-n-octylphosphine oxide, n-octyphosphinic acid), Oleic Acid (OA, 90%, with about 10% made up of conjugated dienoic impurity resulting from oxidation and/or isomerization of linoleic acid impurities and possibly, oleic acid hydroperoxides), 3-Mercaptopropionic Acid (MPA), Acetone, Ethanol (200 proof), Methanol (≥99.9%), and Hexane (anhydrous, 95%, ≤0.01% water, sulfur components) were purchased from Sigma-Aldrich and applied without any modification. A modified colloidal synthetic approach was adopted for synthesis of the CsPbX₃ IPNCs. Briefly, Cs₂CO₃ powder (0.407 g) was put into a 100 mL three-neck round-bottom flask, followed by injection of ODE (20 mL) and OA (1.25 mL) solutions. After vacuum pumping and Ar refilling back and forth in a standard Schlenk-line system for 20 min, the flask was heated under Ar flow to 120° C. until all Cs₂CO₃ dissolved in the ODE and OLA mixed solution. The resulting Cs-oleate precursor was kept at 120° C. to avoid precipitation out of solution.

The CsPbX₃ (X=Cl, Br, I) IPNCs were synthesized using the following steps. First, 0.104 g lead halides (PbCl₂, or 0.138 g PbBr₂, or 0.174 g PbI₂) were put into a 100 mL three-neck-round-bottom flask connected to the Schlenk-line system, which prevents the chemicals from oxygen and moisture and provides an inert gas atmosphere for the reaction. Then, 10 mL ODE, 1 mL OLA, 1 mL OA, and 2 mL TOP were injected successively, followed with alternative vacuum pumping and Ar gas refilling multiple times in the Schlenk-line system for 20 min. The flask was then heated under Ar flow to 120° C. for 1 h to dissolve the lead halide salts and remove the moisture from the reaction solvent. Afterwards, the flask temperature was raised to 150° C. and 0.8 mL of the Cs-oleate precursor fabricated above was quickly injected to lead halide solution at 150° C. to form IPNCs. After 10 s, the reaction was terminated and the flask was cooled in an ice-water bath to obtain the CsPbX₃ (X=Cl, Br, I) IPNCs.

The mixed CsPbBrI₂ IPNCs were synthesized using a modified multi-step process. First, PbI₂ and PbBr₂ precursors were prepared as follows: 0.174 g PbI₂ (or 0.138 g PbBr₂) were put into a 100 mL three-neck-round-bottom flask, followed by successive injections of 10 mL ODE, 1 mL OLA, 1 mL OA, and 2 mL TOP. Alternative vacuum pumping and Ar refilling were carried out in a standard Schlenk-line system for 20 min before heating the flask to 120° C. for 1 h under Ar flow. Next, the PbBr₂ precursor was injected quickly into the PbI₂ precursor at 120° C. at a volume ratio of 1:2. The temperature of the mixed PbI₂ and PbBr₂ precursor solution was raised to 150° C. and then 1.2 mL of the Cs-oleate precursor was injected at 150° C. for 10 s to form CsPbBrI₂ IPNCs. The reaction was terminated after 10 s, followed by cooling the sample in an ice-water bath to obtain the mixed CsPbBrI₂ IPNCs.

In both cases, the resulting solutions contain the IPNCs in the solutions in which the IPNCs were synthesized. Thus, the phrase “synthesis solution” or “SS” is used to refer to these resulting solutions.

Ligand-anchoring process to obtain ligand-anchored (LA) IPNCs: Hexane was added to the synthesis solutions obtained above. Volume ratios of synthesis solutions (SS):hexane were used, including those in the range of from 1:1 to 1:12. Controls used a ratio of 1:0, i.e., no hexane, SS only. As described further below, it was found that hexane played two roles. First, hexane dilutes the concentration of compounds from which the ligands are derived (i.e., OA, OLA). This suppresses dynamic ligand exchange events occurring on the surface of IPNCs, since these events are linearly proportional to ligand concentration. Second, hexane also cleans off species that are more weakly bound to the IPNC surface while promoting the anchoring of more strongly bound ligands.

IPNC's Purification and IPNC's Graphene Photodetector Fabrication: IPNCs in storage solution (i.e., SS (comprising ODE, OLA, OA, TOP)+hexane) were purified as follows. The storage solution was centrifuged by adding a small amount of acetone (1 mL acetone vs. 10 mL storage solution) at the speed of 10,000 RPM at room temperature. Precipitated IPNCs were then re-dissolved in hexane for device fabrication. Monolayer graphene grown using chemical vapor deposition was transferred onto Si/SiO₂ substrates with pre-fabricated Ti/Au electrodes. The IPNCs (10 mg/mL) dispersed in hexane were used as the printing ink, which was ultrasonicated for 2 minutes prior to inkjet printing. The IPNC ink was printed on the graphene channel (4.5 μm×11.2 μm) using an inkjet printer (inkjet microplotter, SonoPlot, Inc.). The device was then naturally dried in a glovebox filled with N₂ for 10 minutes before undergoing ligand exchange as described below.

Ligand exchange: For use in the photodetector devices, the OLA/OA-based insulating ligands on the IPNCs were replaced by shorter and conductive ligands of 3-mercaptopropionic acid (MPA). For MPA ligand exchange, a solution was made by mixing MPA and methanol at a volume ratio of 1:1. After inkjet printing and drying as described above, the entire device was dipped in the MPA solution for 90 s and naturally dried for 1 h in the glovebox. After drying, one layer of PMMA was spin coated on the surface of the device.

Optical and Optoelectronic Characterization: PL spectra of IPNCs were taken using a Cary Eclipse Fluorescence Spectrophotometer. The excitation wavelength for CsPbCl₃ and CsPbBr₃ was 320 nm and the excitation wavelength for CsPbI₃ was 450 nm. Optical absorption spectra were collected using an UV-3600 Shimadzu spectrometer. IPNC morphology and crystal structure were characterized on a field emission transmission electron microscope (FEI Tecnai F20XT) with an acceleration voltage of 200 kV. An Agilent B1505A semiconductor device analyzer was used to test the optoelectronic properties, including current-voltage characteristics under light illumination and dynamic photo response of the photodetectors in a vacuum probe station. A xenon lamp with a monochromometer system (Oriel Apex, Newport) was used to provide the light source with tunable power. The effective optical power absorbed by the active layers of the photodetectors was calibrated using an optical power meter connected to a silicon photodiode (Oriel Apex, Newport). The silicon photodiode was traceable to NREL certification. Noise spectra were measured via a Stanford Research SR760 spectrum analyzer and a battery voltage source.

Nuclear Magnetic Resonance Spectroscopy: For the control samples, ˜25 μL of neat oleic acid, oleylamine, 1-octadecene, trioctylphosphine, and hexane directly from the vendor were added to ˜475 μL of CDCl₃ (Cambridge Isotopes, Tewksbury, MA, USA) and transferred to a 5 mM NMR tube (Wilmad LabGlass, Vineland, NJ, USA). For IPNC samples, ˜25 μL of the SS:hexane solution was mixed with ˜475 μL of CDCl₃ and transferred to a 5 mM NMR tube. NMR spectra were measured using a Bruker AVIII 500 MHz spectrometer equipped with a BBFO cryoprobe. Data was analyzed using MestreNova software (MestreLabs, Santiago De Compostela, Spain).

### Results and Discussion

FIG. 1A illustrates three different types of metal-ligand interactions which can occur on the IPNC surface. These include metal-ligand interactions involving L-type (2 electrons) ligands, X-type (1 electron) ligands, and Z-type (0 electron) ligands. The ligands are neutral, which means the metal-ligand interaction is via covalent bonding with 2, 1, or 0 electrons involved in the L-, X- and Z-types of ligands, respectively. As further described below, NMR experiments confirm that two different X-type ligands (in the form of IPNC(X)₂) are covalently bound to the INPC surface, including oleylammonium halide and oleylammonium carboxylate. These ligands are derived from compounds present in the synthesis solution, oleylamine (OLA) and oleic acid (OA). As shown in FIG. 1B, the OLA compound plays several important roles. First, OLA takes part in an acid/base equilibrium with hydrogen halide to form a covalent bond on the IPNC surface as oleylammonium halide (IPNC(X)₂) (left of FIG. 1B). Second, OLA can react and deprotonate OA to form oleylammonium oleate that binds to the IPNC surface as an ion pair (right of FIG. 1B). Third, OLA may also bind with the IPNC surface cations in its unprotonated state as an L-type ligand (top of FIG. 1B). When the IPNCs are kept in the SS after the synthesis is completed, the high concentration of OLA and OA in the SS results in intermittent, but persistent, ligand binding/detaching. This results in IPNC instability as this process effectively leaves the IPNC surface unpassivated (i.e., unprotected). FIG. 1C schematically illustrates the dynamic ligand exchange process, including detaching/reattaching OLA, versus the more strongly bound oleylammonium oleate and oleylammonium halide.

In order to reduce the dynamic ligand binding/detaching from the IPNC surface, and therefore, the resulting intermittent exposure of the IPNC surface, non-polar hexane solvent was added to the synthesis solutions. Various volume ratios of SS:hexane were used, across a range of from 1:1 to 1:12 (a control of 1:0, i.e., no hexane, SS only, was also used). In addition to diluting the SS (and therefore, suppressing dynamic ligand exchange), hexane cleans out weakly attached species (e.g., OLA) while facilitating binding of species that can form stronger covalent bonds to the IPNC surface (e.g., oleylammonium oleate and oleylammonium halide). This is illustrated in FIG. 1D, showing IPNCs being more fully encapsulated by oleylammonium halide and oleylammonium oleate after hexane injection (right) as opposed to before hexane injection (left).

The crystal structure of CsPbX₃ includes PbX₆ octahedra in which Pb sits in the center surrounded by six halides, and Cs is located at the corner of the cubic vertex. Optical properties (optical absorption and photoluminescence (PL) spectra) of the four different kinds of IPNCs synthesized (CsPbCl₃, CsPbBr₃, CsPbI₃, and CsPbBrI₂) were obtained. The absorption cutoffs were 397 nm, 496 nm, 676 nm, and 648 nm for CsPbCl₃, CsPbBr₃, CsPbI₃, and CsPbBrI₂ IPNCs, respectively. In the absorption spectrum of CsPbBrI₂ IPNCs, the long tail observed was attributed to scattering from aggregates and the IPNCs size distribution. The PL spectra of these four IPNCs were obtained using excitation wavelengths of 320 nm for CsPbCl₃ and CsPbBr₃, and 450 nm for CsPbI₃ and CsPbBrI₂ IPNCs, respectively. The emission peaks of the CsPbCl₃, CsPbBr₃, CsPbI₃, and CsPbBrI₂ IPNCs were observed at around 397 nm, 498 nm, 678 nm, and 650 nm, respectively, matching well to the absorption cutoffs of the corresponding IPNCs. The small hump in the higher energy side of the PL spectrum of CsPbCl₃ IPNCs was ascribed to the strong quantum confinement and well defined excitonic features. It is well matched with the UV absorption spectrum of CsPbCl₃ IPNCs. A minor blue shift of the PL peak and optical cutoff of ˜28 nm was observed by partially replacing I with Br in CsPbBrI₂ as compared to that of pure CsPbI₃ IPNCs. However, as discussed below, the benefit of this minor anion replacement is significant in further improving the IPNC stability. The full-width at half maximum (FWHM) of the PL peaks for the four kinds of IPNCs were 18 nm (CsPbCl₃), 59 nm (CsPbBr₃), 47 nm (CsPbI₃) and 35 nm (CsPbBrI₂), respectively. The wider FWHM of CsPbBr₃ was ascribed to its broader size distribution.

Transmission electron microscopy (TEM) images showed CsPbCl₃ IPNCs to have a cubic shape and an average size of 10.0±0.5 nm. A similar morphology was observed for CsPbBr₃ and CsPbI₃ IPNCs. High-resolution TEM (HRTEM) images of a representative CsPbCl₃ IPNC allowed a lattice distance of ˜0.39 nm to be assigned to the cubic crystal plane of (110). The HRTEM result confirmed that the CsPbCl₃ IPNCs have high crystallinity, which is required for high performance optoelectronic devices.

The TEM images of the mixed-halide CsPbBrI₂ IPNCs also showed a similar cubic shape with an average size of 39±0.5 nm. An HRTEM image of a representative CsPbBrI₂ IPNC gave a lattice fringe of 0.51 nm, approximately matched to the (201) plane of CsPbI₃. High-quality crystallinity of the CsPbBrI₂ IPNCs was also confirmed. The edge length difference between quaternary compounds CsPbBrI₂ IPNCs and ternary compounds CsPbX₃ IPNCs may be ascribed to the different growth kinetics. Structure and elemental maps of a few CsPbBrI₂ IPNCs using the high-angle annular dark-field imaging (HAADF) in a scanning transmission electron microscope (STEM) and the energy-dispersive spectroscopy (EDS) were obtained. The single element maps showed that the Cs, Pb, Br and I element distributions overlap and were uniform, indicating that each of these four elements were incorporated into the CsPbBrI₂ IPNCs uniformly. The limit in the EDS map resolution prevents determination of the elemental depth profile from the IPNC surface. However, the element fraction x of Br in the CsPbBrₓI₃₋ₓ IPNCs is in the range of 0.8<x<1.3. Since this range is close to the intended amount from the synthesis, the smaller than expected blue shift (only 28 nm as opposed to ˜one third of the ˜180 nm between CsPbBr₃ (498 nm) and CsPbI₃ IPNCs (678 nm)) is likely due to the presence of Br interstitials in the CsPbBrₓI₃₋ₓ IPNCs.

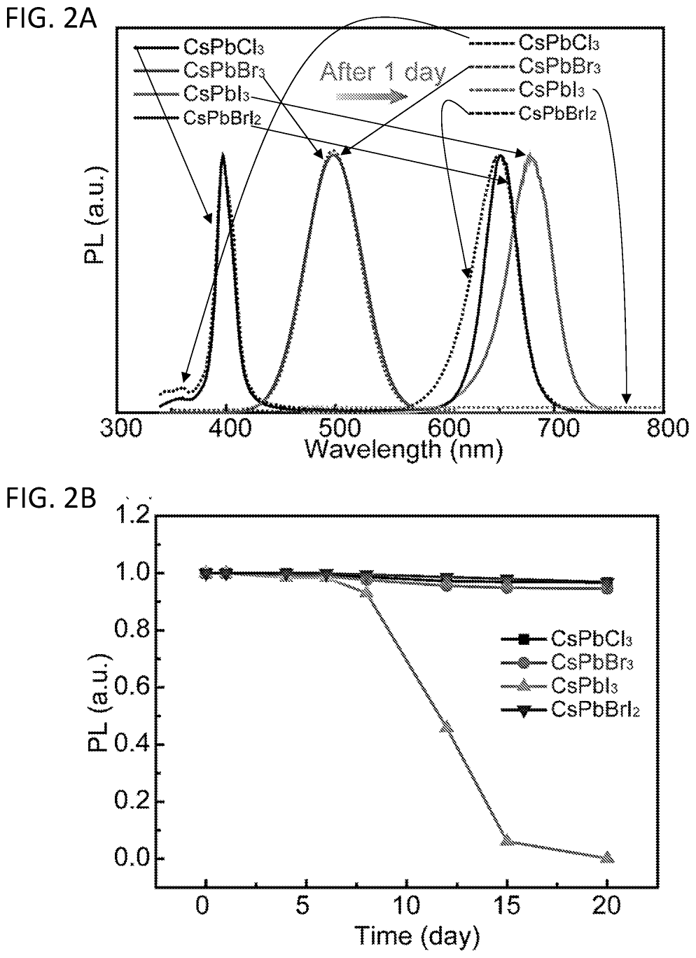

The stability of CsPbX₃ (X=Cl, Br, I) IPNCs stored in the SS only (no hexane) was examined by comparing the PL spectra of the four kinds of IPNCs immediately after synthesis and after one day storage at ambient. The results are shown in FIG. 2A, with PL spectra after synthesis as solid lines and PL spectra after one day storage as dotted lines. Although the PL of CsPbCl₃, CsPbBr₃, and CsPbBrI₂ IPNCs remained intact, the PL of CsPbI₃ IPNCs quenched entirely after one day storage. It is known that CsPbI₃ has the worst stability in solution, due to the instability of its cubic phase at room temperature. However, a partial replacement of iodine with bromide forms CsPbBrₓI₃₋ₓ and stabilizes the cubic phase. Indeed, the comparable stability of CsPbBrI₂ IPNCs to that of CsPbCl₃ and CsPbBr₃ as shown in FIG. 2A illustrates the benefit of partial iodine replacement with bromide. However, degradation of all the IPNCs in SS only was unavoidable over longer times. Degradation is also accelerated in presence of external stimuli such as light, elevated temperature, moisture, and other chemicals.

The optical properties of the three different kinds of CsPbX₃ (X=Cl, Br, I) IPNCs stored at ambient either in SS only (no hexane) or in SS:hexane (volume ratio of 1:12) were examined under natural light and under UV light (360 nm). In SS only, there were no visible changes for CsPbCl₃ and CsPbBr₃ IPNCs after one day. However, the color of CsPbI₃ IPNCs in SS only changed from deep red to white and the photoluminescence disappeared completely after one day. In fact, degradation of the CsPbI₃ IPNCs began almost immediately after storage in SS only.

By contrast, all three kinds of CsPbX₃ (X=Cl, Br, I) IPNCs samples stored in SS:hexane maintained their photoluminescence after 6 days, indicating a remarkable stability enhancement, including for the least stable CsPbI₃ IPNCs. In addition, optical properties (natural light and 360 nm UV light) were examined for CsPbBrI₂ IPNCs as synthesized and after storage at ambient in SS:hexane (volume ratio of 1:12) for 90 days. A pink color under natural light and strong fluorescence under UV light was clearly observed for the as-synthesized sample. After the 90-day storage period, the pink color appeared slightly blue shifted under natural light, while the strong fluorescence under UV light remained. In fact, PL spectra of the pristine (as-synthesized) CsPbBrI₂ IPNCs and after the 90-day storage were nearly identical. Only a minor blue shift of ˜ 5 nm in the PL peak location from 650 nm to 645 nm was observed. As described above, the origin of the stability enhancement is believed to be due to the addition of hexane which suppresses dynamic ligand exchange while promoting the anchoring of the strongly bound ligands (oleylammonium halide and oleylammonium oleate) over weakly bound ligands (oleylamine).

Finally, FIG. 2B shows the PL peak intensity of the four different kinds of IPNCs (CsPbCl₃, CsPbBr₃, CsPbI₃, and CsPbBrI₂) as function of the storage time in SS:hexane (volume ratio of 1:12). In this plot, PL peak values taken at later times are normalized to those of the as-synthesized IPNCs measured immediately after the IPNC synthesis. One of the most striking observations is the enhanced stability of the CsPbI₃ IPNCs. Specifically, the PL peak intensity of the CsPbI₃ IPNCs stored in the SS:hexane solution showed only a negligible reduction after storage for 8 days. This is 1-2 orders of magnitude improvement as compared to only 1-2 hours when stored in SS only. Moreover, improved stability was observed for all four kinds of IPNCs. As shown in FIG. 2B, CsPbCl₃, CsPbBr₃, and CsPbBrI₂ IPNCs showed less than 5% reduction in PL intensity after 20 days storage in SS:hexane solution.

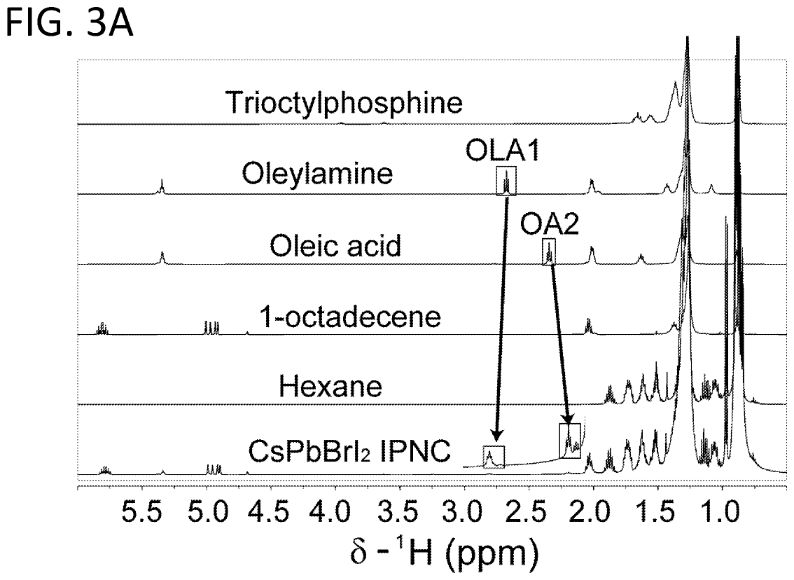

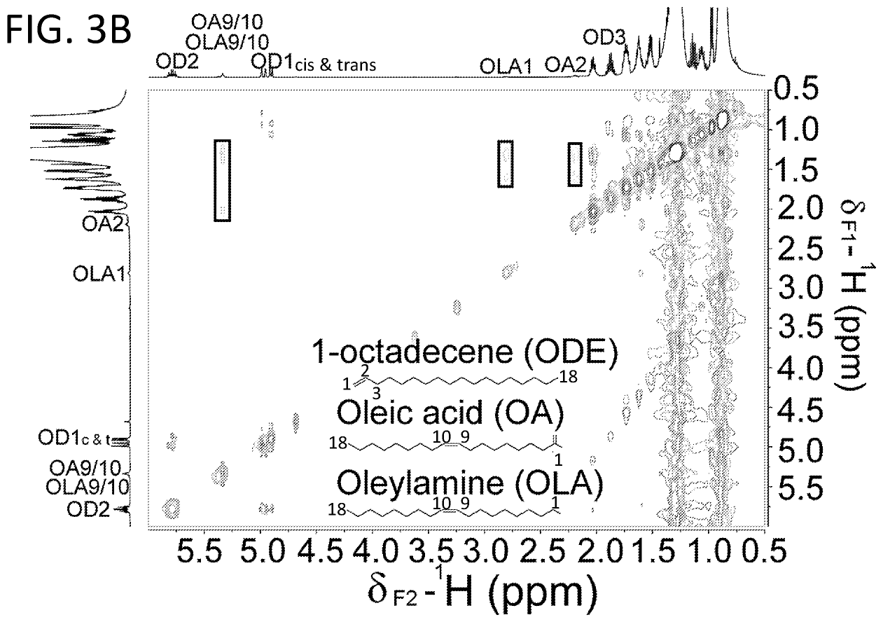

To shed light on the mechanism of the dramatically improved stability of the IPNCs in the SS:hexane solutions, 1D ¹H nuclear magnetic resonance (NMR) and 2D ¹H-¹H nuclear overhauser effect spectroscopy (NOESY) spectra were obtained for the CsPbBrI₂ IPNCs after storage (7 months) in SS:hexane (volume ratio of 1:12). (See FIGS. 3A-3B.) As noted above, the sample tested was an aliquot of the CsPbBrI₂ IPNCs in SS:hexane. The results confirm that both oleylammonium halide and oleylammonium oleate (derived from OLA, OA) are covalently bound to the IPNCs surface after storage in SS:hexane. As shown in FIG. 3A, for OLA, the resonance frequency of the methylene protons adjacent to the amine (e.g., position 1 of OLA or OLA1) shifts from 2.68 ppm in the control spectrum (neat OLA) to 2.81 ppm in the sample spectrum (sample with CsPbBrI₂ IPNCs). For OA, the resonance frequency of the methylene adjacent to the carboxylic acid (e.g., position 2 of OA or OA2) shifts the opposite direction, from 2.34 ppm in the control spectrum to 2.19 ppm in the sample spectrum. The line width of both of these signals also increases in the sample spectrum relative to controls, with a more pronounced effect for OLA relative to OA. An increased line width indicates a decreased spin-spin relaxation time and subsequent rotational correlation time for OLA and OA in the sample with the CsPbBrI₂ IPNCs relative to the samples in free solution (control samples). Moreover, as shown in FIG. 3B, the cross peak and diagonals in the NOESY results have the same sign (e.g., both are positive) for the sample spectrum whereas these peaks have opposite signs in the control spectrum. This change of the sign is consistent with a dramatic decrease in the rotational correlation time of the OLA/OA due to anchoring to the surface of the IPNCs. Taken together, the NMR results indicate that OLA participates in an acid/base equilibrium with hydrogen halide (Br, I) to form oleylammonium halide (IPNC(X)₂) bound to the IPNCs surface. Additionally, oleylammonium oleate is also formed from the deprotonation of oleic acid. In summary, the results confirm that oleylammonium halide and oleylammonium oleate are the strong, covalently bound ligands anchored on the IPNC surface.

Importantly, it was confirmed that the same ligand anchored (LA)-IPNCs obtained by the hexane treatment cannot be obtained by directly adding additional OLA to the SS. To demonstrate this, different volume portions of OLA were added to CsPbBrI₂ IPNCs in SS, and similar stability experiments were conducted. Specifically, six samples of CsPbBrI₂ IPNCs in SS only (no hexane) were prepared and OLA was added at volume portions of 5%, 10%, 20%, 30%, 40%, and 50%, respectively. The samples were illuminated by natural light and UV light at 360 nm. Measurements were taken immediately after the synthesis and after 5 minutes, 5 hours, 26 hours, and 70 hours. The results showed that samples with smaller amounts of OLA were actually more stable. This shows that the addition of OLA actually promotes dynamic ligand exchange and thus reduces the stability of the IPNCs.

The use of hexane to improve stability was further explored by using different SS:hexane volume ratios across a range of from 1:1 to 1:12. Again, photoluminescent measurements were taken from CsPbBrI₂ IPNCs samples under natural light and UV light (360 nm), immediately after synthesis and after storage at ambient for 3 months. The results showed less stability at smaller amounts of hexane. In fact, complete PL quenching was observed in the four samples using SS:hexane volume ratios of 1:1, 1:2, 1:3, and 1:4. By contrast, well preserved PL was observed in the samples having greater amounts of hexane, including SS:hexane volume ratios above 1:4. In order to further quantify the CsPbBrI₂ IPNCs stability, PL spectra of the same CsPbBrI₂ IPNCs samples were obtained. FIG. 4A plots the PL peak intensities of the CsPbBrI₂ IPNCs samples as function of the SS:hexane volume ratio taken after 6 days and 90 days storage at ambient. A clear trend of increasing stability as hexane volume portion increases was observed. The step-like curves of FIG. 4A also show that a critical threshold exists, i.e., a hexane volume portion below which the IPNCs are highly unstable and above which stability substantially improves. The inset of FIG. 4A shows similar results but for CsPbI₃ IPNCs stored in SS:hexane at various volume ratios. Together, the results show that the instability of the IPNCs is the intermittent, but persistent, IPNC surface exposure that occurs due to dynamic ligand exchange. Such exposure leads to attacks by harmful species and therefore, degradation of the IPNCs. Moreover, simply capping IPNC surface with strong binding ligands without also suppressing the subsequent dynamic ligand exchange will not provide large improvements in stability. By contrast, remarkable enhancements in stability are possible even using ligands derived from commonly used compounds such as OLA and OA (as long as the dynamic ligand exchange process is suppressed as described above).

FIG. 4B compares the PL peak intensity of the CsPbBrI₂ IPNCs samples stored in SS:hexane as a function of time. Above the threshold ratio of SS:hexane 1:7, dramatically improved IPNC stability can be observed over the 3-month testing period, again confirming the importance of suppressing the dynamic ligand exchange on the IPNC surface to minimize the IPNC surface intermittent exposure to environment. The results show only a minor reduction of 6.9% in the PL intensity peak for CsPbBrI₂ IPNCs stored in SS:hexane at a volume ratio of 1:12. Finally, FIG. 4C compares the PL spectra of pristine (as-synthesized) CsPbBrI₂ IPNCs, after storage in SS only (no hexane) for two days, and after storage in SS:hexane (1:12) for 300 days at ambient. The sample stored in SS:hexane is referred to as “LA-CsPbBrI₂ IPNCs” since hexane leads to anchoring of the strong oleylammonium halide and oleylammonium oleate ligands as described above. The results show that the pristine CsPbBrI₂ IPNCs are unstable in the SS such that the PL is completely quenched after two days. By contrast, the LA-CsPbBrI₂ LA IPNCs are remarkably stable, even beyond 300 days. The PL peak only has a minor 7 nm blue shift from 650 nm to 643 nm and a reduction of 15% in the PL peak intensity.

In order to demonstrate the applicability of the LA-CsPbBrI₂ IPNCs for optoelectronic applications, they were printed on graphene to form an optically active layer of a photodetector. A schematic of such a photodetector is shown in FIG. 5A. FIG. 5B shows the interface energy level diagram across the heterojunction in the photodetector. Since organic capping ligands having insulating long carbon chains, such as those derived from OA and OLA, act as a barrier layer blocking charge transfer from the IPNCs to graphene, ligand exchange using the short-chain conductive 3-mercaptopropionic acid (MPA) ligand was used on the LA-CsPbBrI₂ IPNC/graphene photodetectors. Comparative CsPbBrI₂ IPNC/graphene photodetectors were also fabricated. They were identical to the LA-CsPbBrI₂ IPNC/graphene photodetectors, except that the IPNCs were not treated with hexane as described herein.

It is noted that Cs⁺ ions in the CsPbX₃ are enclosed in cavities between PbI₆ octahedra, which means the instability of the IPNCs is likely due to the reaction of the Pb and halide dangling bonds with external agents (chemicals, water, etc.) primarily at the IPNC surface. Due to the ionic nature of the MHPs, the charged nature of defects in perovskite materials requires unique passivation strategies like ionic bonding or coordinate bonding to de-activate or neutralize the trap states that resulted from the charged defects. Therefore, a major difference between CsPbBrI₂ IPNCs (i.e., IPNCs that haven't been treated with hexane as described herein) and LA-CsPbBrI₂ IPNCs (i.e., IPNCs that have been treated with hexane as described herein) is primarily the better protection of the IPNC surface during storage, device fabrication (including IPNC purification necessarily requiring exposure to polar solvents), printing, and follow-up MPA ligand exchange. Indeed, photodetectors formed from CsPbBrI₂ IPNCs exhibited poorer performance as compared to those formed from treated LA-CsPbBrI₂ IPNCs.

Specifically, FIG. 5C compares the dynamic photoresponse of the two kinds of photodetectors at the bias voltage of 0.1 V in response to three light on/off cycles. Although the responses are reproducible in terms of the response amplitude and time constant, the LA-CsPbBrI₂ IPNCs/graphene device shows better photoresponse with 1.24 μA photocurrent and 1.8 s response time, as compared to the 1.17 μA photocurrent and 4.8 s response time from the CsPbBrI₂ IPNCs/graphene device. The poorer response from the latter device is indicative of greater unpassivated surface states (forming charge traps). Although such defects may result in relatively minor issues in the short term, their detrimental effect increases in the longer term. This is shown in FIG. 5D, showing that the LA-CsPbBrI₂ IPNCs/graphene photodetectors exhibited less than 10% degradation in photoresponse after more than 70 days under ambient conditions. By contrast, the photoresponse of the CsPbBrI₂ IPNCs/graphene photodetectors decreased by around 29% over the same time frame. The decomposition of the IPNCs accelerates at longer times. After 120 days, the LA-CsPbBrI₂ IPNCs/graphene photodetectors retained 77% of its original photoresponse while the CsPbBrI₂ IPNCs/graphene comparative photodetector had only 26% of its original photoresponse.

The responsivity (R*) is a key figure of merit of a photodetector, and it can be calculated from R*=Iₚₕ/(Pᵢₙ×S), where Iₚₕ is the photocurrent, Pᵢₙ is the incident light intensity 26.8 μW/cm² and the irradiation light wavelength is 600 nm, and S is the active photodetector area. The R* of the CsPbBrI₂ IPNCs/graphene and LA-CsPbBrI₂ IPNCs/graphene photodetectors were 8.66×10⁴ A/W and 9.18×10⁴ A/W, respectively. The specific detectivity (D*) can be calculated based on the equation D*=(S×Δf)^{1/2} NEP, where Δf is band width in Hz, NEP is the noise equivalent power with the unit of A Hz^{1/2}, which is defined as the minimum optical power required to obtain a unity signal-to-noise ratio in a 1 Hz bandwidth. NEP may be calculated from NEP=I̅ₙ̅²̅^{1/2}/Rᵢ, where I̅ₙ̅²̅ is the mean square noise current and can be obtained from the spectra density of the noise power. The spectra of current noise density of the devices show that the I̅ₙ̅²̅ monotonically decreases with increasing frequency, which is enabled by fitting I̅ₙ̅²̅∝/f in the low frequency range up to kHz, indicating the 1/f noise dominates the current noise behavior at low frequencies. The corresponding D* for CsPbBrI₂ IPNCs/graphene and LA-CsPbBrI₂ IPNCs/graphene photodetectors were 3.9×10¹¹ Jones and 4.2×10¹¹ Jones, respectively.

### Conclusions

In summary, a new ligand anchoring process has been described in this Example to achieve superior long-term colloidal stability for IPNCs, especially iodine-based IPNCs. This Example has also revealed that the dominant mechanism underlying IPNC instability is the highly dynamic ligand exchange that leads to exposed IPNC surfaces. The results further show that hexane is an excellent stability promotor for suppressing this dynamic ligand exchange while promoting the anchoring of strong, covalently bound ligands derived from OLA and OA. These results are in stark contrast to moderate stability improvements obtained by replacing OLA and OA with other compounds to form other types of strongly bound ligands on IPNC surfaces. The increased stability afforded by the present process extends to photodetectors formed from the LA-IPNCs, including after the OLA/OA derived anchoring ligands are exchanged with MPA ligands in such devices.

The word illustrative is used herein to mean serving as an example, instance, or illustration. Any aspect or design described herein as illustrative is not necessarily to be construed as preferred or advantageous over other aspects or designs. Further, for the purposes of this disclosure and unless otherwise specified, “a” and “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A stabilized colloidal composition comprising metal halide perovskite nanocrystals dispersed within a liquid phase medium comprising
a synthesis solution from which the metal halide perovskite nanocrystals were synthesized, the synthesis solution comprising a dynamic binding compound capable of forming a covalent bond to surfaces of the metal halide perovskite nanocrystals as a dynamic binding ligand; and
a stability promoter.

2. The composition of claim 1, wherein the metal halide perovskite nanocrystals have formula APb(X₁)_{z}(X₂)_{3-z}, wherein A is selected from alkali metals, X is selected from halogens, and z ranges from 0 to 3.

3. The composition of claim 2, wherein A is Cs.

4. The composition of claim 1, wherein the dynamic binding compound is selected from a fatty acid, a fatty amine, and combinations thereof.

5. The composition of claim 4, wherein the dynamic binding compound comprises oleylamine and oleic acid.

6. The composition of claim 1, wherein the synthesis solution consists of the dynamic binding compound and optionally, one or more other dynamic binding compounds.

7. The composition of claim 6, wherein the dynamic binding compound is selected from a group consisting of 1-octadecene, oleylamine, oleic acid, trioctylphosphine, and combinations thereof.

8. The composition of claim 1, wherein the synthesis solution and the stability promoter are present at a volume ratio of (synthesis solution):(stability promoter) of 1:5 or greater.

9. The composition of claim 8, wherein the volume ratio is in a range of from 1:5 to 1:20.

10. The composition of claim 1, wherein the liquid phase medium comprises at least 5% by volume of the synthesis solution and no more than 95% by volume of the stability promoter.

11. The composition of claim 10, wherein the liquid phase medium comprises at least 10% by volume of the synthesis solution and no more than 90% by volume of the stability promoter.

12. The composition of claim 1, wherein the stability promoter promotes covalent binding of one type of dynamic binding ligand in the liquid phase medium over another, different type of dynamic binding ligand in the liquid phase medium.

13. The composition of claim 1, wherein the stability promoter is an alkane.

14. The composition of claim 13, wherein the stability promoter is an unsubstituted, linear alkane.

15. The composition of claim 13, wherein the alkane has from 5 to 59 carbon atoms.

16. The composition of claim 13, wherein the alkane is hexane.

17. The composition of claim 1, characterized by a photoluminescence spectrum having a peak that exhibits a reduction in intensity of no more than 25% after 90 days at ambient as compared to day 0.

18. The composition of claim 1, wherein the metal halide perovskite nanocrystals have formula APb(X₁)_{z}(X₂)_{3-z}, wherein A is selected from alkali metals, X is selected from halogens, and z ranges from 0 to 3, wherein the liquid phase medium comprises at least 5% by volume of the synthesis solution and no more than 95% by volume of the stability promoter, wherein the stability promoter is an alkane, and wherein the dynamic binding compound comprises oleylamine and oleic acid.

19. A method of making the composition of claim 1, the method comprising adding the stability promoter to the synthesis solution.

20. A method of using the composition of claim 1, the method comprising precipitating the metal halide perovskite nanocrystals from the stabilized colloidal composition; and redispersing the precipitated metal halide perovskite nanocrystals in a solvent.
